(19) United States
(12) Patent Application Publication
(10) Pub. No.: US 2019/0090209 A1
(43) Pub. Date: Mar. 21, 2019

(54) OSCILLATION MITIGATION USING SUCCESSIVE APPROXIMATION IN A SIGNAL BOOSTER

(71) Applicant: WILSON ELECTRONICS, LLC, St. George, UT (US)

(72) Inventors: Miklos Zoltan, Santa Clara, UT (US); Christopher Ken Ashworth, St. George, UT (US)

(21) Appl. No.: 16/137,147

(22) Filed: Sep. 20, 2018

Related U.S. Application Data
(60) Provisional application No. 62/561,042, filed on Sep. 20, 2017.

(51) Int. Cl. H04W 52/52

(52) U.S. Cl. CPC H04W 52/52; H04W 88/04

(57) ABSTRACT

Technology for a signal booster operable to mitigate an oscillation is disclosed. The signal booster can include a signal path configured to carry a signal in a defined band. The signal booster can include a controller configured to detect an oscillation in the signal booster. The controller can determine a range of signal attenuation levels that are applicable by the controller. The controller can apply one or more signal attenuation levels within the range of signal attenuation levels to the signal booster to mitigate the oscillation. A signal attenuation level can be iteratively adjusted until a minimum signal attenuation level within the range of signal attenuation levels is applied that mitigates the oscillation in the signal booster.

### RELATED APPLICATIONS

The present application claims the benefit of U.S. Provisional Patent Application No. 62/561,042, filed Sep. 20, 2017 with a docket number of 3969-134.PROV, the entire specification of which is hereby incorporated by reference in its entirety for all purposes.

### BACKGROUND

Signal boosters and repeaters can be used to increase the quality of wireless communication between a wireless device and a wireless communication access point, such as a cell tower. Signal boosters can improve the quality of the wireless communication by amplifying, filtering, and/or applying other processing techniques to uplink and downlink signals communicated between the wireless device and the wireless communication access point.

As an example, the signal booster can receive, via an antenna, downlink signals from the wireless communication access point. The signal booster can amplify the downlink signal and then provide an amplified downlink signal to the wireless device. In other words, the signal booster can act as a relay between the wireless device and the wireless communication access point. As a result, the wireless device can receive a stronger signal from the wireless communication access point. Similarly, uplink signals from the wireless device (e.g., telephone calls and other data) can be directed to the signal booster. The signal booster can amplify the uplink signals before communicating, via an antenna, the uplink signals to the wireless communication access point.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure; and, wherein:

FIG. 1 illustrates a signal booster in communication with a wireless device and a base station in accordance with an example;

FIG. 2 illustrates a cellular signal booster configured to amplify uplink (UL) and downlink (DL) signals using one or more downlink signal paths and one or more uplink signal paths in accordance with an example;

FIG. 3 illustrates a signal booster operable to mitigate an oscillation in accordance with an example;

FIG. 4 is a flow chart that illustrates operations for mitigating an oscillation in a signal booster in accordance with an example;

FIG. 5 illustrates a technique for mitigating an oscillation in a signal booster in accordance with an example;

FIG. 6 illustrates a method for mitigating an oscillation in a repeater in accordance with an example; and

FIG. 7 illustrates a wireless device in accordance with an example.

Reference will now be made to the exemplary embodiments illustrated, and specific language will be used herein to describe the same. It will nevertheless be understood that no limitation of the scope of the invention is thereby intended.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating steps and operations and do not necessarily indicate a particular order or sequence.

### Example Embodiments

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

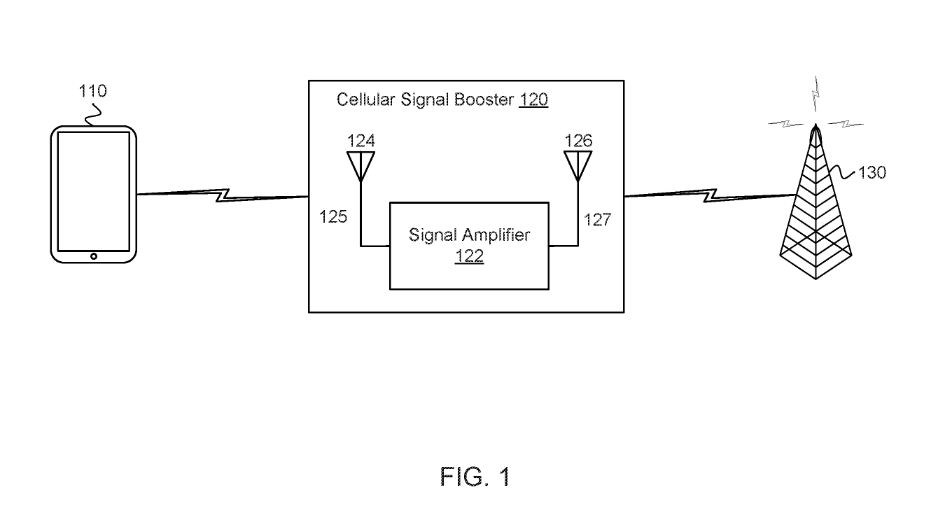

FIG. 1 illustrates an exemplary signal booster 120 in communication with a wireless device 110 and a base station 130. The signal booster 120 can be referred to as a repeater. A repeater can be an electronic device used to amplify (or boost) signals. The signal booster 120 (also referred to as a cellular signal amplifier) can improve the quality of wireless communication by amplifying, filtering, and/or applying other processing techniques via a signal amplifier 122 to uplink signals communicated from the wireless device 110 to the base station 130 and/or downlink signals communicated from the base station 130 to the wireless device 110. In other words, the signal booster 120 can amplify or boost uplink signals and/or downlink signals bi-directionally. In one example, the signal booster 120 can be at a fixed location, such as in a home or office. Alternatively, the signal booster 120 can be attached to a mobile object, such as a vehicle or a wireless device 110.

In one configuration, the signal booster 120 can include an integrated device antenna 124 (e.g., an inside antenna or a coupling antenna) and an integrated node antenna 126 (e.g., an outside antenna). The integrated node antenna 126 can receive the downlink signal from the base station 130. The downlink signal can be provided to the signal amplifier 122 via a second coaxial cable 127 or other type of radio frequency connection operable to communicate radio frequency signals. The signal amplifier 122 can include one or more cellular signal amplifiers for amplification and filtering. The downlink signal that has been amplified and filtered can be provided to the integrated device antenna 124 via a first coaxial cable 125 or other type of radio frequency connection operable to communicate radio frequency signals. The integrated device antenna 124 can wirelessly communicate the downlink signal that has been amplified and filtered to the wireless device 110.

Similarly, the integrated device antenna 124 can receive an uplink signal from the wireless device 110. The uplink signal can be provided to the signal amplifier 122 via the first coaxial cable 125 or other type of radio frequency connection operable to communicate radio frequency signals. The signal amplifier 122 can include one or more cellular signal amplifiers for amplification and filtering. The uplink signal that has been amplified and filtered can be provided to the integrated node antenna 126 via the second coaxial cable 127 or other type of radio frequency connection operable to communicate radio frequency signals. The integrated device antenna 126 can communicate the uplink signal that has been amplified and filtered to the base station 130.

In one example, the signal booster 120 can filter the uplink and downlink signals using any suitable analog or digital filtering technology including, but not limited to, surface acoustic wave (SAW) filters, bulk acoustic wave (BAW) filters, film bulk acoustic resonator (FBAR) filters, ceramic filters, waveguide filters or low-temperature co-fired ceramic (LTCC) filters.

In one example, the signal booster 120 can send uplink signals to a node and/or receive downlink signals from the node. The node can comprise a wireless wide area network (WWAN) access point (AP), a base station (BS), an evolved Node B (eNB), a baseband unit (BBU), a remote radio head (RRH), a remote radio equipment (RRE), a relay station (RS), a radio equipment (RE), a remote radio unit (RRU), a central processing module (CPM), or another type of WWAN access point.

In one configuration, the signal booster 120 used to amplify the uplink and/or a downlink signal is a handheld booster. The handheld booster can be implemented in a sleeve of the wireless device 110. The wireless device sleeve can be attached to the wireless device 110, but can be removed as needed. In this configuration, the signal booster 120 can automatically power down or cease amplification when the wireless device 110 approaches a particular base station. In other words, the signal booster 120 can determine to stop performing signal amplification when the quality of uplink and/or downlink signals is above a defined threshold based on a location of the wireless device 110 in relation to the base station 130.

In one example, the signal booster 120 can include a battery to provide power to various components, such as the signal amplifier 122, the integrated device antenna 124 and the integrated node antenna 126. The battery can also power the wireless device 110 (e.g., phone or tablet). Alternatively, the signal booster 120 can receive power from the wireless device 110.

In one configuration, the signal booster 120 can be a Federal Communications Commission (FCC)-compatible consumer signal booster. As a non-limiting example, the signal booster 120 can be compatible with FCC Part 20 or 47 Code of Federal Regulations (C.F.R.) Part 20.21 (Mar. 21, 2013). In addition, the signal booster 120 can operate on the frequencies used for the provision of subscriber-based services under parts 22 (Cellular), 24 (Broadband PCS), 27 (AWS-1, 700 MHz Lower A-E Blocks, and 700 MHz Upper C Block), and 90 (Specialized Mobile Radio) of 47 C.F.R. The signal booster 120 can be configured to automatically self-monitor its operation to ensure compliance with applicable noise and gain limits. The signal booster 120 can either self-correct or shut down automatically if the signal booster's operations violate the regulations defined in FCC Part 20.21.

In one configuration, the signal booster 120 can improve the wireless connection between the wireless device 110 and the base station 130 (e.g., cell tower) or another type of wireless wide area network (WWAN) access point (AP). The signal booster 120 can boost signals for cellular standards, such as the Third Generation Partnership Project (3GPP) Long Term Evolution (LTE) Release 8, 9, 10, 11, 12, or 13 standards or Institute of Electronics and Electrical Engineers (IEEE) 802.16. In one configuration, the signal booster 120 can boost signals for 3GPP LTE Release 13.0.0 (March 2016) or other desired releases. The signal booster 120 can boost signals from the 3GPP Technical Specification 36.101 (Release 12 Jun. 2015) bands or LTE frequency bands. For example, the signal booster 120 can boost signals from the LTE frequency bands: 2, 4, 5, 12, 13, 17, and 25. In addition, the signal booster 120 can boost selected frequency bands based on the country or region in which the signal booster is used, including any of bands 1-70 or other bands, as disclosed in ETSI TS136 104 V13.5.0 (2016-10).

The number of LTE frequency bands and the level of signal improvement can vary based on a particular wireless device, cellular node, or location. Additional domestic and international frequencies can also be included to offer increased functionality. Selected models of the signal booster 120 can be configured to operate with selected frequency bands based on the location of use. In another example, the signal booster 120 can automatically sense from the wireless device 110 or base station 130 (or GPS, etc.) which frequencies are used, which can be a benefit for international travelers.

In one example, the integrated device antenna 124 and the integrated node antenna 126 can be comprised of a single antenna, an antenna array, or have a telescoping form-factor. In another example, the integrated device antenna 124 and the integrated node antenna 126 can be a microchip antenna. An example of a microchip antenna is AMMAL001. In yet another example, the integrated device antenna 124 and the integrated node antenna 126 can be a printed circuit board (PCB) antenna. An example of a PCB antenna is TE 2118310-1.

In one example, the integrated device antenna 124 can receive uplink (UL) signals from the wireless device 100 and transmit DL signals to the wireless device 100 using a single antenna. Alternatively, the integrated device antenna 124 can receive UL signals from the wireless device 100 using a dedicated UL antenna, and the integrated device antenna 124 can transmit DL signals to the wireless device 100 using a dedicated DL antenna.

In one example, the integrated device antenna 124 can communicate with the wireless device 110 using near field communication. Alternatively, the integrated device antenna 124 can communicate with the wireless device 110 using far field communication.

In one example, the integrated node antenna 126 can receive downlink (DL) signals from the base station 130 and transmit uplink (UL) signals to the base station 130 via a single antenna. Alternatively, the integrated node antenna 126 can receive DL signals from the base station 130 using a dedicated DL antenna, and the integrated node antenna 126 can transmit UL signals to the base station 130 using a dedicated UL antenna.

In one configuration, multiple signal boosters can be used to amplify UL and DL signals. For example, a first signal booster can be used to amplify UL signals and a second signal booster can be used to amplify DL signals. In addition, different signal boosters can be used to amplify different frequency ranges.

In one configuration, the signal booster 120 can be configured to identify when the wireless device 110 receives a relatively strong downlink signal. An example of a strong downlink signal can be a downlink signal with a signal strength greater than approximately −80 dBm. The signal booster 120 can be configured to automatically turn off selected features, such as amplification, to conserve battery life. When the signal booster 120 senses that the wireless device 110 is receiving a relatively weak downlink signal, the integrated booster can be configured to provide amplification of the downlink signal. An example of a weak downlink signal can be a downlink signal with a signal strength less than −80 dBm.

In one example, the signal booster 120 can also include one or more of: a waterproof casing, a shock absorbent casing, a flip-cover, a wallet, or extra memory storage for the wireless device. In one example, extra memory storage can be achieved with a direct connection between the signal booster 120 and the wireless device 110. In another example, Near-Field Communications (NFC), Bluetooth v4.0, Bluetooth Low Energy, Bluetooth v4.1, Bluetooth v4.2, Bluetooth 5, Ultra High Frequency (UHF), 3GPP LTE, Institute of Electronics and Electrical Engineers (IEEE) 802.11a, IEEE 802.11b, IEEE 802.11g, IEEE 802.11n, IEEE 802.11ac, or IEEE 802.11ad can be used to couple the signal booster 120 with the wireless device 110 to enable data from the wireless device 110 to be communicated to and stored in the extra memory storage that is integrated in the signal booster 120. Alternatively, a connector can be used to connect the wireless device 110 to the extra memory storage.

In one example, the signal booster 120 can include photovoltaic cells or solar panels as a technique of charging the integrated battery and/or a battery of the wireless device 110. In another example, the signal booster 120 can be configured to communicate directly with other wireless devices with signal boosters. In one example, the integrated node antenna 126 can communicate over Very High Frequency (VHF) communications directly with integrated node antennas of other signal boosters. The signal booster 120 can be configured to communicate with the wireless device 110 through a direct connection, Near-Field Communications (NFC), Bluetooth v4.0, Bluetooth Low Energy, Bluetooth v4.1, Bluetooth v4.2, Ultra High Frequency (UHF), 3GPP LTE, Institute of Electronics and Electrical Engineers (IEEE) 802.11a, IEEE 802.11b, IEEE 802.11g, IEEE 802.11n, IEEE 802.11ac, IEEE 802.11ad, a TV White Space Band (TVWS), or any other industrial, scientific and medical (ISM) radio band. Examples of such ISM bands include 2.4 GHz, 3.6 GHz, 4.9 GHz, 5 GHz, or 5.9 GHz. This configuration can allow data to pass at high rates between multiple wireless devices with signal boosters. This configuration can also allow users to send text messages, initiate phone calls, and engage in video communications between wireless devices with signal boosters. In one example, the integrated node antenna 126 can be configured to couple to the wireless device 110. In other words, communications between the integrated node antenna 126 and the wireless device 110 can bypass the integrated booster.

In another example, a separate VHF node antenna can be configured to communicate over VHF communications directly with separate VHF node antennas of other signal boosters. This configuration can allow the integrated node antenna 126 to be used for simultaneous cellular communications. The separate VHF node antenna can be configured to communicate with the wireless device 110 through a direct connection, Near-Field Communications (NFC), Bluetooth v4.0, Bluetooth Low Energy, Bluetooth v4.1, Bluetooth v4.2, Ultra High Frequency (UHF), 3GPP LTE, Institute of Electronics and Electrical Engineers (IEEE) 802.11a, IEEE 802.11b, IEEE 802.11g, IEEE 802.11n, IEEE 802.11ac, IEEE 802.11ad, a TV White Space Band (TVWS), or any other industrial, scientific and medical (ISM) radio band.

In one configuration, the signal booster 120 can be configured for satellite communication. In one example, the integrated node antenna 126 can be configured to act as a satellite communication antenna. In another example, a separate node antenna can be used for satellite communications. The signal booster 120 can extend the range of coverage of the wireless device 110 configured for satellite communication. The integrated node antenna 126 can receive downlink signals from satellite communications for the wireless device 110. The signal booster 120 can filter and amplify the downlink signals from the satellite communication. In another example, during satellite communications, the wireless device 110 can be configured to couple to the signal booster 120 via a direct connection or an ISM radio band. Examples of such ISM bands include 2.4 GHz, 3.6 GHz, 4.9 GHz, 5 GHz, or 5.9 GHz.

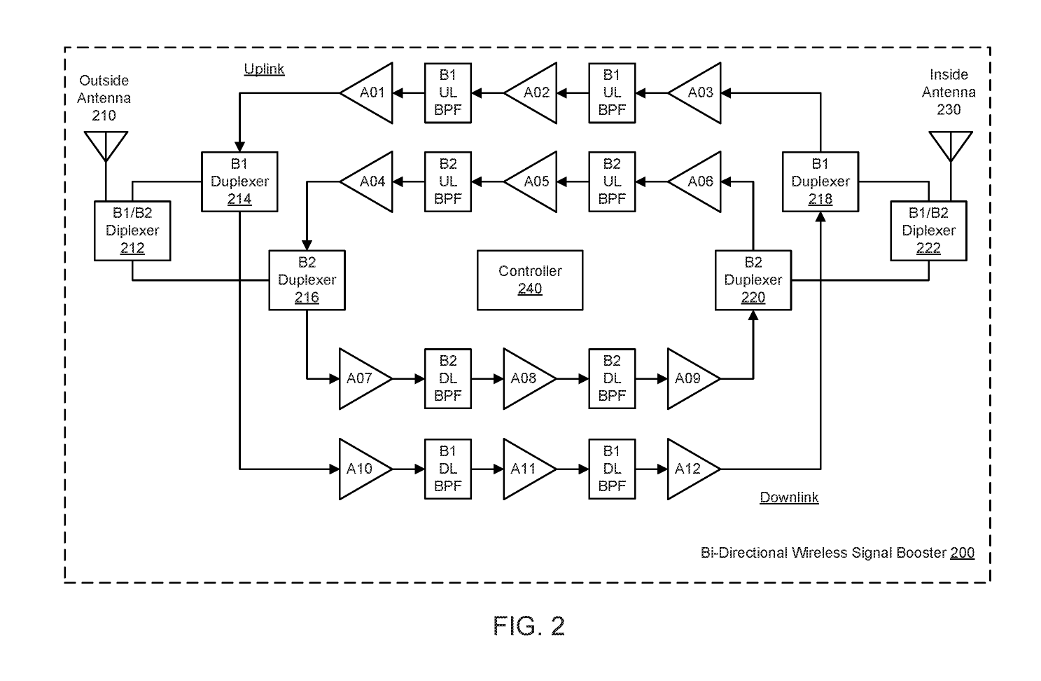

FIG. 2 illustrates an exemplary bi-directional wireless signal booster 200 configured to amplify uplink (UL) and downlink (DL) signals using a separate signal path for each UL frequency band and DL frequency band and a controller 240. An outside antenna 210, or an integrated node antenna, can receive a downlink signal. For example, the downlink signal can be received from a base station (not shown). The downlink signal can be provided to a first B1/B2 diplexer 212, wherein B1 represents a first frequency band and B2 represents a second frequency band. The first B1/B2 diplexer 212 can create a B1 downlink signal path and a B2 downlink signal path. Therefore, a downlink signal that is associated with B1 can travel along the B1 downlink signal path to a first B1 duplexer 214, or a downlink signal that is associated with B2 can travel along the B2 downlink signal path to a first B2 duplexer 216. After passing the first B1 duplexer 214, the downlink signal can travel through a series of amplifiers (e.g., A10, A11 and A12) and downlink band pass filters (BPF) to a second B1 duplexer 218. Alternatively, after passing the first B2 duplexer 216, the downlink can travel through a series of amplifiers (e.g., A07, A08 and A09) and downlink band pass filters (BFF) to a second B2 duplexer 220. At this point, the downlink signal (B1 or B2) has been amplified and filtered in accordance with the type of amplifiers and BPFs included in the bi-directional wireless signal booster 200. The downlink signals from the second B1 duplexer 218 or the second B2 duplexer 220, respectively, can be provided to a second B1/B2 diplexer 222. The second B1/B2 diplexer 222 can provide an amplified downlink signal to an inside antenna 230, or an integrated device antenna. The inside antenna 230 can communicate the amplified downlink signal to a wireless device (not shown), such as a mobile phone.

In one example, the inside antenna 230 can receive an uplink (UL) signal from the wireless device. The uplink signal can be provided to the second B1/B2 diplexer 222. The second B1/B2 diplexer 222 can create a B1 uplink signal path and a B2 uplink signal path. Therefore, an uplink signal that is associated with B1 can travel along the B1 uplink signal path to the second B1 duplexer 218, or an uplink signal that is associated with B2 can travel along the B2 uplink signal path to the second B2 duplexer 222. After passing the second B1 duplexer 218, the uplink signal can travel through a series of amplifiers (e.g., A01, A02 and A03) and uplink band pass filters (BPF) to the first B1 duplexer 214. Alternatively, after passing the second B2 duplexer 220, the uplink signal can travel through a series of amplifiers (e.g., A04, A05 and A06) and uplink band pass filters (BPF) to the first B2 duplexer 216. At this point, the uplink signal (B1 or B2) has been amplified and filtered in accordance with the type of amplifiers and BFFs included in the bi-directional wireless signal booster 200. The uplink signals from the first B1 duplexer 214 or the first B2 duplexer 216, respectively, can be provided to the first B1/B2 diplexer 212. The first B1/B2 diplexer 212 can provide an amplified uplink signal to the outside antenna 210. The outside antenna can communicate the amplified uplink signal to the base station.

In one example, the bi-directional wireless signal booster 200 can be a 6-band booster. In other words, the bi-directional wireless signal booster 200 can perform amplification and filtering for downlink and uplink signals having a frequency in bands B1, B2, B3 B4, B5 and/or B6.

In one example, the bi-directional wireless signal booster 200 can use the duplexers to separate the uplink and downlink frequency bands, which are then amplified and filtered separately. A multiple-band cellular signal booster can typically have dedicated radio frequency (RF) amplifiers (gain blocks), RF detectors, variable RF attenuators and RF filters for each uplink and downlink band.

In one example, an oscillation can occur in a signal booster or repeater. Generally speaking, the oscillation can be created when outside and inside antennas that are internally located in the signal booster are within a defined distance from each other, such that a level of booster amplification is greater than a path loss between the antennas and a positive feedback loop exists. With signal boosters, two antennas that are within a defined distance or proximity from each other can produce an RF squeal.

From an installation perspective, a customer may install signal booster antennas relatively close to each other (e.g., due to constraints in a home), but a greater gain of the signal booster requires that the antennas be installed further away from each other. When antennas are installed relatively close to each other, the oscillation can occur in either a downlink path or an uplink path of the signal booster. In some cases, downlink and/or uplink signals can be analyzed at the signal booster to determine the presence of or confirm an oscillation created by an amplifier in the signal booster.

In one example, oscillations can be caused due to feedback or noise, which can be amplified in the signal booster over a period of time. Since the signal booster can include both the uplink signal path and the downlink signal path, there is a loop that has the potential to cause internal oscillations. For example, in a feedback path from one antenna to another antenna, one antenna can transmit to the other antenna. An oscillation can occur when a loss between antennas is less than a gain in the signal booster. An oscillation may not occur when a loss between the antennas is greater than a gain in the signal booster. In addition, an oscillation can occur when an output port of the signal booster couples back to an input port of the signal booster due to poor shielding.

In one example, the outside antenna in the signal booster can receive a signal outside a building and transmit the signal to the one or more amplifiers. The one or more amplifiers can boost the signal and then send an amplified signal to the inside antenna. The inside antenna can broadcast the amplified signal to an area with poor signal coverage. An oscillation can occur when a broadcasted signal from the inside antenna is detected by the outside antenna, and the broadcasted signal is passed through the signal booster again, which can result in a background noise. This noise can result in poor reception on the device being used. In some cases, the signal booster can automatically reduce their capabilities or shut down when an oscillation or feedback begins to occur.

In one configuration, a controller in the signal booster can detect an oscillation in the signal booster. The controller can reduce a gain in the signal booster by a selected amount (in dB) to cease the oscillation in the signal booster. In other words, the oscillation can be stopped or mitigated by reducing the gain by the selected amount in the signal booster to an oscillation threshold level at which oscillation begins. The controller can reduce the gain in the signal booster by increasing a signal attenuation level in the signal booster. This level can be a predetermined threshold level based on certain non-linearities that occur in oscillation. More specifically, the controller can reduce the gain for a selected band in a selected signal path (i.e., the uplink signal path or the downlink signal path) in the signal booster. In addition, the controller can further reduce the gain in the signal booster further, below the oscillation threshold level, by a selected amount (in dB) to create an oscillation margin. The oscillation margin can be a margin between an operating gain of the signal booster and a gain at which oscillation begins (the oscillation threshold level) in the signal booster. The oscillation margin can ensure that a noise floor does not rise above a level allowed by the set oscillation margin. More specifically, the controller can further reduce the gain for the selected band in the selected signal path (i.e., the uplink signal path or the downlink signal path) in the signal booster, thereby creating the oscillation margin.

In one example, the controller in the signal booster can detect a presence of an oscillation for each individual band in the signal booster. The controller can reduce a gain for a given band by the first amount to stop the oscillation, and then reduce the gain for that same band by the second amount to confirm the existence of the oscillation margin. The controller can repeat this procedure for each band supported in the signal booster.

In one example, the controller in the signal booster can decrease a gain in a selected signal path (e.g., uplink signal path and/or downlink signal path) by increasing a signal attenuation level in the selected signal path or by adjusting a variable gain amplifier in the selected signal path. The controller can increase the signal attenuation level with respect to a certain band in the selected signal path (i.e., the attenuation increase can be performed on a per band basis). In addition, the controller can increase the gain in the selected signal path by decreasing a signal attenuation level in the selected signal path or by adjusting a variable gain amplifier in the selected signal path. The controller can decrease the signal attenuation level with respect to a certain band in the selected signal path (i.e., the attenuation decrease can be performed on a per band basis). In one example, a defined amount of attenuation can be designed into the signal booster, and a certain amount of attenuation can be added or removed to decrease the gain in the selected signal path or increase the gain in the selected signal path, respectively.

In one configuration, FCC regulations allow for a maximum time limit of 300 millisecond (ms) to mitigate an oscillation in a signal booster (or repeater). However, for a more complex signal booster, it is essential to use an oscillation detection and mitigation algorithm that mitigates an oscillation faster than the 300 ms time limit specified by the FCC, especially when there are several bands and ports that are to be handled when mitigating the oscillation for the signal booster.

In past solutions, oscillation mitigation techniques would determine a required attenuation increase (or gain decrease) by incrementing a signal attenuation level by a fixed number of dB (e.g., incrementing the attenuation in 2 dB steps). In past solutions, a controller in the signal booster would increase the signal attenuation level (e.g., by 2 dB) and determine whether the oscillation stopped. If not, the controller would again increase the signal attenuation level (e.g., by another 2 dB) and determine whether the oscillation stopped. The controller would continue this process until the oscillation was mitigated in the signal booster. In other words, the controller would continue this process until an appropriate attenuation was identified that stopped the oscillation at the signal booster. However, this technique would consume an increased amount of time, especially when a relatively large attenuation increase was needed to mitigate the oscillation (as the controller would gradually increase the signal attenuation level). In addition, due to the increased amount of time, the controller would typically increase the signal attenuation level in larger increments (e.g., by 2 dB as opposed to 1 dB or 0.5 dB).

In the present technology, rather than gradually increasing the signal attenuation level (e.g., by 2 dB increments) and determining each time whether the oscillation has ceased, a novel technique for oscillation mitigation can involve adjusting the signal attenuation level using successive approximation until an optimal signal attenuation level is identified to mitigate the oscillation. The optimal signal attenuation level to mitigate the oscillation can be a minimum signal attenuation level within a range of possible signal attenuation level that successfully mitigates the oscillation in the signal booster. Therefore, successive approximation can be utilized to identify a cutback signal attenuation level at which the oscillation ceases at the signal booster. By utilizing successive approximation, the oscillation mitigation can be performed in a reduced amount of time (as opposed to gradually incrementing the signal attenuation level step-by-step and determining after each increase whether the oscillation has ceased).

As used herein, the term “successive approximation” refers to any applicable technique for iteratively selecting and applying a signal attenuation level within a range of possible signal attenuation levels until a minimum signal attenuation level within the range of possible signal attenuation levels is applied that mitigates the oscillation in the signal booster. For example, in the present technology, successive approximation may incorporate the Babylonian technique for finding square roots of numbers, fixed-point iteration, Halley's technique for finding zeros of functions, Newton's technique for finding zeros of functions, the Picard-Lindelöf theorem and/or the Runge-Kutta technique. Successive approximation can involve iteratively adjusting (e.g., increasing and/or decreasing) the signal attenuation level within the range of possible signal attenuation levels until the minimum signal attenuation level is applied that mitigates the oscillation in the signal booster. In general, successive approximation may be utilized to determine the minimum signal attenuation level in a reduced amount of time, thereby reducing an amount of time to mitigate the oscillation in the signal booster.

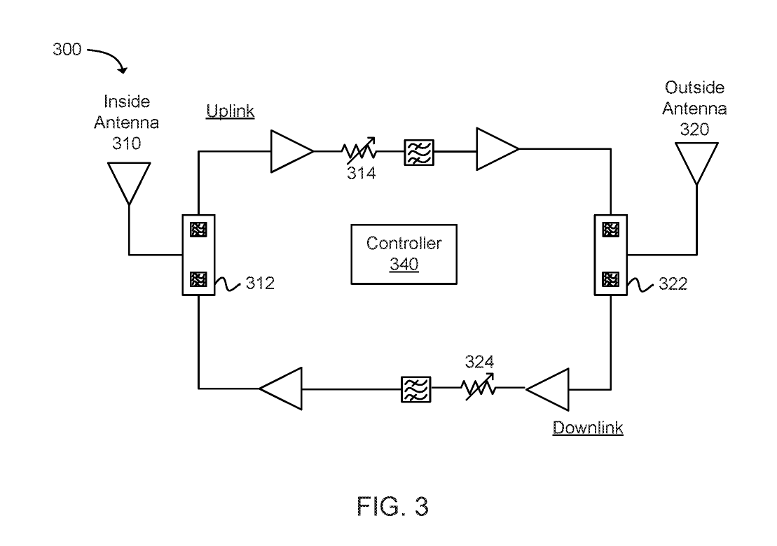

FIG. 3 illustrates an exemplary signal booster 300 (or repeater). The signal booster 300 can include an inside antenna 310 and a first duplexer 312 communicatively coupled to the inside antenna 310. The signal booster 300 can include an outside antenna 320 and a second duplexer 322 communicatively coupled to the outside antenna 320. The signal booster 300 can include an uplink signal path and a downlink signal path. The uplink signal path and the downlink signal path can be communicatively coupled between the first duplexer 312 and the second duplexer 322. In this example, the first duplexer 312 and the second duplexer 322 can be dual-input single-output (DISO) analog bandpass filters. In addition, in this example, the uplink signal path and the downlink signal path can each include one or more amplifiers (e.g., low noise amplifiers (LNAs), power amplifiers (PAs)) and one or more bandpass filters. In this example, the bandpass filters can be single-input single-output (S ISO) analog bandpass filters.

In one example, the uplink signal path and the downlink signal path can each include a variable attenuator. For example, the uplink signal path can include a variable attenuator 314 and the downlink signal path can include a variable attenuator 324. The variable attenuator 314 can increase or decrease an amount of attenuation for a specific band in the uplink signal path, and the variable attenuator 334 can increase or decrease an amount of attenuation for a specific band in the downlink signal path. The variable attenuators 314, 324 can be increased in order to decrease a gain for a given band in a respective signal path, or the variable attenuators 314, 324 can be decreased in order to increase a gain for a given band in a respective signal path.

In one example, the outside antenna 320 in the signal booster 300 can receive a downlink signal from a base station (not shown). The downlink signal can be passed from the outside antenna 320 to the second duplexer 322. The second duplexer 322 can direct the downlink signal to the downlink signal path. The downlink signal can be amplified and filtered using one or more amplifiers and one or more filters, respectively, on the downlink signal path. The downlink signal (which has been amplified and filtered) can be directed to the first duplexer 312, and then to the inside antenna 310 in the signal booster 300. The inside antenna 310 can transmit the downlink signal to a mobile device (not shown).

In another example, the inside antenna 310 can receive an uplink signal from the mobile device. The uplink signal can be passed from the inside antenna 310 to the first duplexer 312. The first duplexer 312 can direct the uplink signal to the uplink signal path. The uplink signal can be amplified and filtered using one or more amplifiers and one or more filters, respectively, on the uplink signal path. The uplink signal (which has been amplified and filtered) can be directed to the second duplexer 322, and then to the outside antenna 320 in the signal booster 300. The outside antenna 320 can transmit the uplink signal to the base station.

In one configuration, the signal booster 300 can include a controller 340. The controller 340 can be configured to detect and mitigate oscillations in the signal booster 300. In one example, the controller 340 can detect an oscillation in a defined band and/or in a signal path in the signal booster 300. For example, the controller 340 can detect an oscillation in a given band in an uplink signal path or a downlink signal path in the signal booster 300.

After detection of the oscillation, the controller 340 can mitigate the oscillation using a successive approximation technique. The controller 340 can determine a range of signal attenuation levels that are capable of being applied to the signal path, as well as an increment value within the range of signal attenuation levels. In other words, the range of signal attenuation levels can include a certain number of possible values. As a non-limiting example, the range of signal attenuation levels can be 0 to 16 dB, and the signal attenuation levels can be applied in 0.5 dB increments. Therefore, in this example, the range of signal attenuation levels can include 32 possible signal attenuation levels (i.e., the controller 340 can apply up to 32 different signal attenuation levels). As another non-limiting example, the range of signal attenuation levels can be 0 to 16 dB, and the signal attenuation levels can be applied in 1 dB increments. Therefore, in this example, the range of signal attenuation levels can include 16 possible signal attenuation levels (i.e., the controller 340 can apply up to 16 different signal attenuation levels). As yet another non-limiting example, the range of signal attenuation levels can be 0 to 32 dB, and the signal attenuation levels can be applied in 0.5 dB increments. Therefore, in this example, the range of signal attenuation levels can include 64 possible signal attenuation levels (i.e., the controller 340 can apply up to 64 different signal attenuation levels).

In one example, after determining the range of signal attenuation levels that are capable of being applied to the signal path (and the increment value within the range of signal attenuation levels), the controller 340 can select a first signal attenuation level within the range of signal attenuation levels using successive approximation. For example, the controller 340 can select a first signal attenuation level that is halfway in the range of signal attenuation levels using successive approximation (i.e., halfway between a minimum signal attenuation level and a maximum signal attenuation level). The controller 340 can apply the first signal attenuation level (using one of variable attenuators 314, 324) to possibly mitigate the oscillation in the given band of the signal path in the signal booster 300. The controller 340 can determine whether the application of the first signal attenuation level is successful in mitigating the oscillation.

In one example, the controller 340 can determine that the application of the first signal attenuation level is successful in mitigating the oscillation. In this case, the controller 340 can know that the first signal attenuation level is too high, and it is possible to reduce the signal attenuation level and still cause the oscillation to cease to exist in the given band of the signal path. Thus, the controller 340 can select a second signal attenuation level within the range of signal attenuation levels that is less than the first signal attenuation level using successive approximation. For example, the controller 340 can select a second signal attenuation level that is halfway between the minimum signal attenuation level and the first signal attenuation level. The controller 340 can apply the second signal attenuation level to possibly mitigate the oscillation in the given band of the signal path in the signal booster 300. The controller 340 can determine whether the application of the second signal attenuation level is successful in mitigating the oscillation.

In an alternative example, the controller 340 can determine that the application of the first signal attenuation level is not successful in mitigating the oscillation. In this case, the controller 340 can know that the second signal attenuation level is too low, and the signal attenuation level is to be increased in order to mitigate the oscillation in the given band of the signal path. Thus, the controller 340 can select a second signal attenuation level within the range of signal attenuation levels that is greater than the first signal attenuation level using successive approximation. For example, the controller 340 can select a second signal attenuation level that is halfway between the first signal attenuation level and the maximum signal attenuation level. The controller 340 can apply the second signal attenuation level to possibly mitigate the oscillation in the given band of the signal path in the signal booster 300. The controller 340 can determine whether the application of the second signal attenuation level is successful in mitigating the oscillation.

In one example, the controller 340 can determine that the second signal attenuation level (that is halfway between the minimum signal attenuation level and the first signal attenuation level) is successful in mitigating the oscillation. In this case, the controller 340 can know that the second signal attenuation level is still too high, and it is possible to further reduce the signal attenuation level and still cause the oscillation to cease to exist in the given band of the signal path. Thus, the controller 340 can select a third signal attenuation level within the range of signal attenuation levels that is less than the second signal attenuation level using successive approximation. For example, the controller 340 can select a third signal attenuation level that is halfway between the minimum signal attenuation level and the second signal attenuation level. The controller 340 can apply the third signal attenuation level to possibly mitigate the oscillation in the given band of the signal path in the signal booster 300. The controller 340 can determine whether the application of the third signal attenuation level is successful in mitigating the oscillation.

In an alternative example, the controller 340 can determine that the second signal attenuation level (that is halfway between the first signal attenuation level and the maximum signal attenuation level) is still not successful in mitigating the oscillation. In this case, the controller 340 can know that the second signal attenuation level is still too low, and the signal attenuation level is to be further increased in order to mitigate the oscillation in the given band of the signal path. Thus, the controller 340 can select a third signal attenuation level within the range of signal attenuation levels that is greater than the second signal attenuation level using successive approximation. For example, the controller 340 can select a third signal attenuation level that is halfway between the second signal attenuation level and the maximum signal attenuation level. The controller 340 can apply the third signal attenuation level to possibly mitigate the oscillation in the given band of the signal path in the signal booster 300. The controller 340 can determine whether the application of the third signal attenuation level is successful in mitigating the oscillation.

In one example, the controller 340 can repeatedly adjust the signal attenuation level using successive approximation (e.g., by increasing and/or decreasing the signal attenuation level within the range of signal attenuation levels) and determine whether each new signal attenuation level is successful in mitigating the oscillation in the given band of the signal path in the signal booster 300. The controller 340 can continue to adjust the signal attenuation level until a minimum signal attenuation level is identified within the range of signal attenuation levels that mitigates the oscillation in the given band of the signal path in the signal booster 300. In other words, the controller 340 can iteratively apply additional signal attenuation levels within the range of signal attenuation levels to the given band of the signal path, and the additional signal attenuation levels can be determined using successive approximation. The additional signal attenuation levels can be iteratively applied until the minimum signal attenuation level is identified within the range of signal attenuation levels that mitigates the oscillation in the given band of the signal path in the signal booster 300.

In one example, a number of signal attenuation levels that are applied by one of the variable attenuators 314, 324 to the given band of the signal path to identify the minimum signal attenuation level can correspond to the range of signal attenuation levels that are capable of being applied by the controller 340. For example, when the range of signal attenuation levels includes 32 possible attenuation values, the controller 340 can identify the minimum signal attenuation level after applying a maximum of 5 different attenuations that are determined using successive approximation (i.e., 2⁵ is equal to 32). As another example, when the range of signal attenuation levels includes 64 possible attenuation values, the controller 340 can identify the minimum signal attenuation level after applying a maximum of 6 different attenuations that are determined using successive approximation (i.e., 2⁶ is equal to 64). As yet another example, when the range of signal attenuation levels includes 128 possible attenuation values, the controller 340 can identify the minimum signal attenuation level after applying a maximum of 7 different attenuations that are determined using successive approximation (i.e., 2⁷ is equal to 128).

In one example, the variable attenuators 314, 324 can be 5-bit variable attenuators. Thus, the variable attenuators 314, 324 can apply 32 (or 2⁵) individual levels of attenuation to the given band of the signal path. In another example, the variable attenuators 314, 324 can be 6-bit variable attenuators. Thus, the variable attenuators 314, 324 can apply 64 (or 2⁶) individual levels of attenuation to the given band of the signal path. In yet another example, the variable attenuators 314, 324 can be 7-bit variable attenuators. Thus, the variable attenuators 314, 324 can apply 128 (or 2⁷) individual levels of attenuation to the given band of the signal path.

In one example, the controller 340 can mitigate the oscillation in the given band of the signal path in the signal booster 300 using successive approximation in an amount of time that complies with a maximum oscillation mitigation time limit defined by a governing body. For example, the controller 340 can mitigate the oscillation using successive approximation within a maximum oscillation mitigation time limit required by the FCC. In addition, the controller 340 can mitigate the oscillation within the maximum oscillation mitigation time limit using successive approximation while still being able to adjust signal attenuation levels at a granularity that is more refined as compared to earlier solutions. For example, the controller 340 can adjust the signal attenuation level with a granularity of 0.5 dB or 1 dB using successive approximation (as opposed to 2 dB), and can still mitigate the oscillation within the maximum oscillation mitigation time limit defined by the governing body. As a result, the controller 340 does not apply more attenuation than is needed to mitigate the oscillation.

In one example, the controller 340 can apply the first signal attenuation level, determine whether the application of the first signal attenuation level has mitigated the oscillation, apply the second signal attenuation level, determine whether the application of the second signal attenuation level has mitigated the oscillation, apply the third signal attenuation level, and so on. The second signal attenuation level can be less than or greater than the first signal attenuation level, the third signal attenuation level can be less than or greater than second signal attenuation level, and so on. In one example, the controller 340 can increase the signal attenuation level (i.e., the second signal attenuation level can be greater than the first signal attenuation level) to reduce a gain for the given band of the signal path. In another example, the controller 340 can decrease the signal attenuation level (i.e., the second signal attenuation level can be less than the first signal attenuation level) to increase a gain for the given band of the signal path.

As a non-limiting example, the controller 340 can detect an oscillation in the signal booster 300. The controller 340 can determine that a range of signal attenuation levels that are capable of being applied to the signal booster 300 is from 0 dB to 32 dB, and the signal attenuation levels in the range of signal attenuation levels are in increments of 0.5 dB. Therefore, in this example, the range of signal attenuation levels can include 64 possible values. The controller 340 can iteratively apply one or more signal attenuation levels within the range of signal attenuation levels to mitigate the oscillation. The controller 340 can iteratively apply the one or more signal attenuation levels until a minimum attenuation is identified within the range of signal attenuation levels that mitigates the oscillation. In this example, the minimum signal attenuation level can be 30 dB, but the controller 340 does not know this value initially and can iteratively determine the value of 30 dB using successive approximation. For example, the controller 340 can select a first signal attenuation level of 16 dB (i.e., halfway between 0 dB and 32 dB), and then apply the first signal attenuation level in the signal booster 300. The controller 340 can determine that the first signal attenuation level of 16 dB does not mitigate the oscillation. The controller 340 can select a second signal attenuation level of 24 dB using successive approximation (i.e., halfway between 16 dB and 32 dB), and then apply the second signal attenuation level in the signal booster 300. The controller 340 can determine that the second signal attenuation level of 24 dB does not mitigate the oscillation. The controller 340 can select a third signal attenuation level of 28 dB using successive approximation (i.e., halfway between 24 dB and 32 dB), and then apply the third signal attenuation level in the signal booster 300. The controller 340 can determine that the third signal attenuation level of 28 dB does not mitigate the oscillation. The controller 340 can select a fourth signal attenuation level of 30 dB using successive approximation (i.e., halfway between 28 dB and 32 dB), and then apply the fourth signal attenuation level in the signal booster 300. The controller 340 can determine that the fourth signal attenuation level of 30 dB mitigates the oscillation. However, the controller 340 does not yet know if the fourth signal attenuation level of 30 dB is the minimum signal attenuation level that mitigates the oscillation. Thus, the controller 340 can select a fifth signal attenuation level of 31 dB using successive approximation (i.e., halfway between 30 dB and 32 dB), and then apply the fifth signal attenuation level in the signal booster 300. The controller 340 can determine that the fifth signal attenuation level of 31 dB does not mitigate the oscillation. Therefore, the controller 340 can determine that the signal attenuation level of 30 dB is the minimum signal attenuation level that mitigates the oscillation. In this example, the controller 340 can determine the minimum signal attenuation level of 30 dB in five steps.

As another non-limiting example, the minimum signal attenuation level can be 13 dB, but the controller 340 does not know this value initially and can iteratively determine the value of 13 dB using successive approximation. For example, the controller 340 can select a first signal attenuation level of 16 dB (i.e., halfway between 0 dB and 32 dB), and then apply the first signal attenuation level in the signal booster 300. The controller 340 can determine that the first signal attenuation level of 16 dB mitigates the oscillation. The controller 340 can select a second signal attenuation level of 8 dB using successive approximation (i.e., halfway between 0 dB and 16 dB), and then apply the second signal attenuation level in the signal booster 300. The controller 340 can determine that the second signal attenuation level of 8 dB does not mitigate the oscillation. The controller 340 can select a third signal attenuation level of 12 dB using successive approximation (i.e., halfway between 8 dB and 16 dB), and then apply the third signal attenuation level in the signal booster 300. The controller 340 can determine that the third signal attenuation level of 12 dB does not mitigate the oscillation. The controller 340 can select a fourth signal attenuation level of 14 dB using successive approximation (i.e., halfway between 12 dB and 16 dB), and then apply the fourth signal attenuation level in the signal booster 300. The controller 340 can determine that the fourth signal attenuation level of 14 dB mitigates the oscillation. The controller 340 can select a fifth signal attenuation level of 13 dB using successive approximation (i.e., halfway between 12 dB and 14 dB), and then apply the fifth signal attenuation level in the signal booster 300. The controller 340 can determine that the signal attenuation level of 13 dB is the minimum signal attenuation level that mitigates the oscillation (since the controller 340 has already determined that 12 dB does not mitigate the oscillation and 14 dB does mitigate the oscillation). In this example, the controller 340 can determine the minimum signal attenuation level of 13 dB in five steps.

In contrast, using previous solutions, a signal booster would gradually increase a signal attenuation level until an oscillation was mitigated in the signal booster. For example, if the minimum signal attenuation level was 15 dB within a range from 0 dB to 32 dB, the signal booster would gradually increase the signal attenuation level (e.g., in more coarse increments of 2 dB to meet an oscillation mitigation time limit defined by the FCC). Thus, in previous solutions, the signal booster would gradually increase the signal attenuation level from 0 dB to 16 dB in 2 dB increments. In this example, after applying the signal attenuation level of 16 dB, the signal booster would determine that the oscillation has been mitigated. This process would take 8 steps, and in addition, the identified signal attenuation level of 16 dB was not exact as the minimum signal attenuation level was 15 dB, but the signal booster would not be able to determine the minimum signal attenuation level of 15 dB. In previous solutions, oscillation mitigation would take even longer when the minimum signal attenuation level was relatively high within the range (e.g., 30 dB). Therefore, the ability to determine the minimum signal attenuation level using successive approximation can be useful in determining the minimum signal attenuation level in a reduced number of steps and with an increased granularity level.

In one example, the controller 340 can utilize successive approximation that slightly varies as compared to above. In this example, the range of signal attenuation levels can span 30 dB, and the controller 340 can apply signal attenuation levels within the range can step down in 7 dB increments. If one signal attenuation level does not mitigate the oscillation, then the controller 340 can step down another 7 dB, and then apply the resulting signal attenuation level. If the oscillation is mitigated, then the controller 340 can step up by 3 dB, and then apply the resulting signal attenuation level. As a result, the minimum signal attenuation level within the range of signal attenuation levels can be applied in a reduced amount of time using successive approximation. In addition, specific values for increasing the signal attenuation level (e.g., 3 dB) or decreasing the signal attenuation level (e.g., 7 dB) can be selectively changed.

In one example, the signal booster can determine whether the oscillation is mitigated by performing a power amplifier (PA) off/on test. For example, a PA can be turned off, a sample of a signal strength can be selected, and then the PA can be turned back on. A number of samples can be collected to determine whether the oscillation has been mitigated or not. Therefore, when the number of steps utilized to determine the minimum signal attenuation level to mitigate the oscillation is increased, the amount of time taken to mitigate the oscillation is also increased. Therefore, it is desirable to utilize a reduced number of steps in determining the minimum signal attenuation level (which is possible when successive approximation is utilized to determine the minimum signal attenuation level).

In one configuration, the signal booster 300 can include a radio frequency (RF) signal detector, a processing unit (or controller), an adjustable RF signal attenuator or an adjustable RF gain block and/or a controllable RF gain stage (amplifier) to detect and mitigate the oscillations. The RF signal detector can output a direct current (DC) voltage proportional to an amplitude (or power) of an RF signal. The processing unit can be a device that measures and evaluates the DC voltage output of the RF detector. The processing unit can control the gain of the signal booster 300, and can enable or disable enabling one or more gain states (e.g., power amplifiers). In addition, the signal booster 300 can utilize minimum individual on/off control per port, and possibly individual gain control per port.

In one configuration, the controller 340 can detect an oscillation in the signal booster 300. The controller 340 can reduce a gain in the signal booster 300 by a first amount to cease the oscillation in the signal booster 300. In other words, the oscillation can be stopped by reducing the gain by the first amount in the signal booster 300 to an oscillation threshold level at which oscillation begins. This level can be a predetermined threshold level based on certain non-linearities that occur in oscillation. In one example, the controller 340 can reduce the gain in the signal booster 300 further, below the oscillation threshold, by a second amount to create an oscillation margin. The oscillation margin can be a margin between an operating gain of the signal booster 300 and a gain at which oscillation begins (the oscillation threshold) in the signal booster 300. The oscillation margin can ensure that a noise floor does not rise above a level allowed by the set oscillation margin. The controller 340 can modify (e.g., reduce) the gain in the signal booster 300 further by a third amount to create an offset to the oscillation margin. In other words, the offset can create an additional margin to the oscillation margin. In effect, the oscillation margin can be increased by the offset (based on the reduction of the gain in the signal booster 300 by the third amount). The first amount, the second amount and the third amount can be represented in decibels (dB). In addition, the offset to the oscillation margin can reduce a transmitted noise power from the signal booster 300. The transmitted noise power can increase as the signal booster 300 gets closer to oscillation, so the offset to the oscillation margin can function to reduce the transmitted noise power.

In one example, the controller 340 can periodically increase the gain in the signal booster 300. The offset to the oscillation margin can reduce a likelihood that the increase to the gain causes a subsequent oscillation at the signal booster 300. In addition, the gain can be periodically increased to confirm an existence of the oscillation margin. In other words, the gain can be periodically increased to confirm an expected oscillation margin. In one example, the controller 340 can increase the gain by the oscillation margin. In another example, the controller 340 can increase the gain by the offset to the oscillation margin. In yet another example, the controller 340 can increase the gain by the oscillation margin and the offset to the oscillation margin.

In one example, the gain can be periodically increased to ensure that the signal booster 300 has a proper margin. The feedback path can be changed due to a variety of issues, such as time, temperature, objects moving around, a vehicle or the mobile device moving around, etc. The feedback path can be changed when antenna becomes bumped or moved. Therefore, to ensure that the oscillation margin (e.g., 5 dB) is still present (and is at an expected level), the signal booster can be periodically bumped up (i.e., the gain can be increased to remove the oscillation margin). In other words, the signal booster 300 can periodically remove the oscillation margin to ensure that the oscillation margin is still accurate, and this can be referred to as a ‘bump-up’, and the noise floor can increase during bump-up.

In one example, an amount of amplification applied by the signal booster can change due to a number of factors, including changes in the atmosphere, movement of objects around the inside and outside antennas, movement of the inside and outside antennas, movement of the wireless device, and so forth. The periodic bump-up (or increase of the gain in the signal booster) can function to remove the oscillation margin to ensure that the signal booster 300 is still operating within the oscillation margin.

In one configuration, the signal booster 300 can be turned on and an oscillation can be detected. The signal booster 300 can add noise to the network. The noise (or noise floor) can increase as a donor and server booster antennas become closer together. Upon detection of the oscillation, a gain in the signal booster 300 can be reduced until the signal booster 300 stops oscillating at the oscillation threshold level. Then, the controller 340 can drop the gain below the oscillation threshold level by the oscillation margin (e.g., 5 dB). In this example, after dropping the gain by the oscillation margin, there is 5 dB of margin before the signal booster 300 is operating at or above the oscillation threshold level. After determining an oscillation point, the controller 340 can drop the gain by the oscillation margin (e.g., 5 dB). The signal booster 300 can periodically increase the gain (e.g., every 10 minutes) to confirm an expected oscillation margin. When this occurs, the signal booster 300 can increase the gain by the oscillation margin (e.g., 5 dB), so after the increase to the gain, the signal booster 300 can be back to operating at the edge of oscillation again. However, this can result in non-linear increases in the noise floor (i.e. more than 5 dB). Therefore, after the gain is dropped by the oscillation margin (e.g., 5 dB), the signal booster 300 can drop the again by an offset to the oscillation margin (e.g., 1 dB, 2 dB, or 3 dB). In other words, the signal booster 300 can further reduce the gain by an additional margin to the oscillation margin (e.g., 2 dB). In this case, when the signal booster periodically increases the gain by the oscillation margin (e.g., 5 dB), even with the increase to the gain, the signal booster 300 can be the offset to the oscillation margin (e.g., 2 dB) away from the oscillation threshold level. Due to the offset to the oscillation margin or the additional margin to the oscillation margin (e.g., 2 dB), the signal booster 300 is not back to the edge of oscillation after increasing the gain by the oscillation margin (e.g., 5 dB). Rather, the signal booster 300 still has a 2 dB margin from the point of oscillation. This can allow the booster to periodically test that it is operating within the oscillation margin level, while reducing the chances of periodically operating within the oscillation region and increasing the noise floor by more than the oscillation margin level (e.g. 5 dB).

In the above non-limiting example, the oscillation margin is 5 dB and the offset to the oscillation margin (or additional margin to the oscillation margin) is 2 dB. However, these values are not intended to be limiting. Therefore, the oscillation margin can be 5 dB, 10 dB, 15 dB, etc., and the offset to the oscillation margin (or additional margin to the oscillation margin) can be 1 dB, 2 dB, 5 dB, etc.

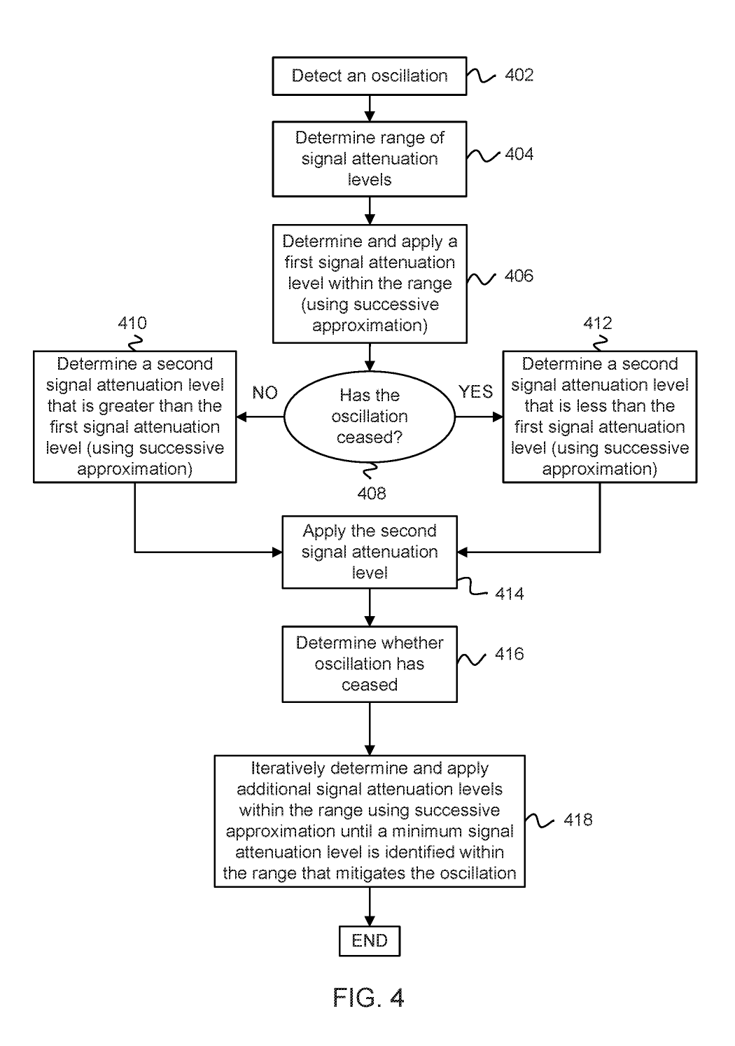

FIG. 4 is an exemplary flow chart that illustrates operations for mitigating an oscillation in a signal booster. An oscillation in the signal booster can be detected, as in block 402. A range of signal attenuation levels can be determined, as in block 404. A first signal attenuation level within the range of signal attenuation levels can be determined using successive approximation, and the first signal attenuation level can be applied to possibly mitigate the oscillation in the signal booster, as in block 406. A determination can be made as to whether the application of the first signal attenuation level has caused the oscillation to stop or cease, as in block 408. If the oscillation has not ceased, then a second signal attenuation level within the range of signal attenuation levels that is greater than the first signal attenuation level can be determined using successive approximation, as in block 410. Alternatively, if the oscillation has ceased, then a second signal attenuation level within the range of signal attenuation levels that is less than the first signal attenuation level can be determined using successive approximation, as in block 412. The second signal attenuation level can be applied to possibly mitigate the oscillation in the signal booster, as in block 414. A determination can be made as to whether the application of the second signal attenuation level has caused the oscillation to stop or cease, as in block 416. Additional signal attenuation levels within the range of signal attenuation levels can be determined using successive approximation, as in block 418. The additional signal attenuation levels can be applied until a minimum signal attenuation level is identified within the range of signal attenuation levels that mitigates the oscillation in the signal booster.

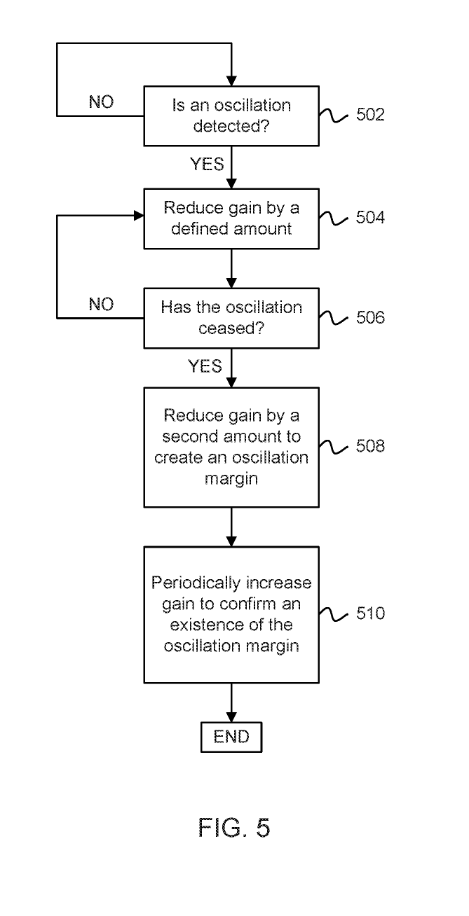

FIG. 5 illustrates an exemplary technique for mitigating an oscillation in a signal booster (or repeater). The technique can be implemented using a controller in the signal booster. In operation 502, the controller can determine whether an oscillation is detected in the signal booster. The controller can determine whether there is an oscillation for a selected band. If an oscillation is not detected in the signal booster, then the controller can continue to check for oscillations that occur in the signal booster. If an oscillation is detected in the signal booster, then the controller can reduce a gain by a defined amount (in dB) to mitigate the oscillation, as in operation 504. In operation 506, the controller can determine whether the oscillation has ceased or stopped. If the oscillation has not ceased or stopped, then the controller can continue to reduce the gain until the oscillation has ceased or stopped. In operation 508, after the oscillation as ceased or stopped the controller can further reduce the gain by a second amount (in dB) to create an oscillation margin. In operation 510, the controller can periodically increase (or bump up) the gain for the selected band to confirm an existence of the oscillation margin.

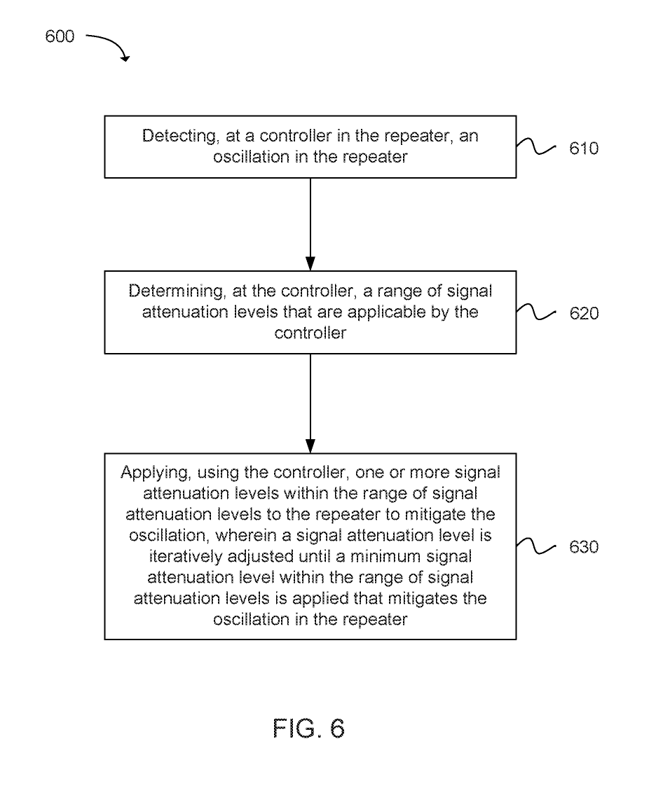

FIG. 6 illustrates an exemplary method for mitigating an oscillation in a repeater. The method may be executed as instructions on a machine, where the instructions are included on at least one computer readable medium or one non-transitory machine readable storage medium. The method includes the operation of detecting, at a controller in the repeater, an oscillation in the repeater, as in block 610. The method can include the operation of determining, at the controller, a range of signal attenuation levels that are applicable by the controller, as in block 620. The method can include the operation of applying, using the controller, one or more signal attenuation levels within the range of signal attenuation levels to the repeater to mitigate the oscillation, wherein a signal attenuation level is iteratively adjusted until a minimum signal attenuation level within the range of signal attenuation levels is applied that mitigates the oscillation in the repeater, as in block 630.

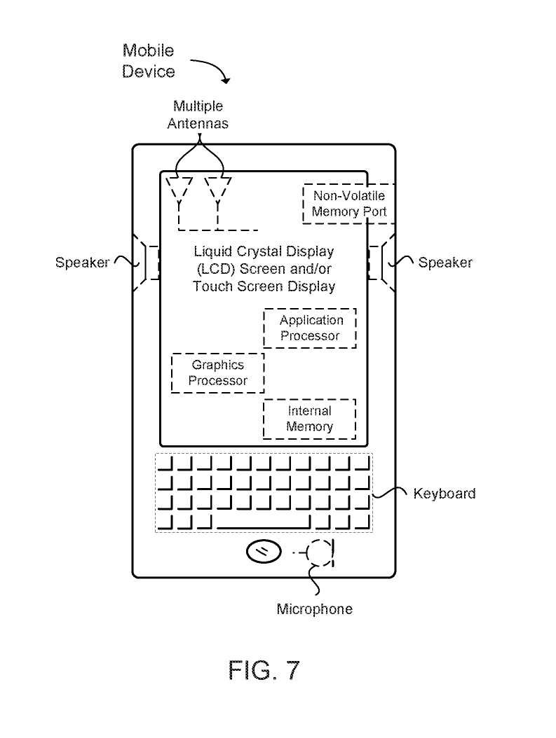

FIG. 7 provides an example illustration of the wireless device, such as a user equipment (UE), a mobile station (MS), a mobile communication device, a tablet, a handset, a wireless transceiver coupled to a processor, or other type of wireless device. The wireless device can include one or more antennas configured to communicate with a node or transmission station, such as an access point (AP), a base station (BS), an evolved Node B (eNB), a baseband unit (BBU), a remote radio head (RRH), a remote radio equipment (RRE), a relay station (RS), a radio equipment (RE), a remote radio unit (RRU), a central processing module (CPM), or other type of wireless wide area network (WWAN) access point. The wireless device can communicate using separate antennas for each wireless communication standard or shared antennas for multiple wireless communication standards. The wireless device can communicate in a wireless local area network (WLAN), a wireless personal area network (WPAN), and/or a WWAN.

FIG. 7 also provides an illustration of a microphone and one or more speakers that can be used for audio input and output from the wireless device. The display screen can be a liquid crystal display (LCD) screen, or other type of display screen such as an organic light emitting diode (OLED) display. The display screen can be configured as a touch screen. The touch screen can use capacitive, resistive, or another type of touch screen technology. An application processor and a graphics processor can be coupled to internal memory to provide processing and display capabilities. A non-volatile memory port can also be used to provide data input/output options to a user. The non-volatile memory port can also be used to expand the memory capabilities of the wireless device. A keyboard can be with the wireless device or wirelessly connected to the wireless device to provide additional user input. A virtual keyboard can also be provided using the touch screen.

### EXAMPLES

The following examples pertain to specific technology embodiments and point out specific features, elements, or actions that can be used or otherwise combined in achieving such embodiments.

Example 1 includes a repeater operable to mitigate an oscillation, the repeater comprising: a signal path configured to carry a signal in a defined band; and a controller configured to: detect an oscillation in the repeater; determine a range of signal attenuation levels that are applicable by the controller; and apply one or more signal attenuation levels within the range of signal attenuation levels to the repeater to mitigate the oscillation, wherein a signal attenuation level is iteratively adjusted using successive approximation until a minimum signal attenuation level within the range of signal attenuation levels is applied that mitigates the oscillation in the repeater.

Example 2 includes the repeater of Example 1, wherein the controller is configured to: detect the oscillation in the defined band or in the signal path of the repeater; and apply the one or more signal attenuation levels within the range of signal attenuation levels to the defined band or to the signal path of the repeater.

Example 3 includes the repeater of any of Examples 1 to 2, wherein the controller configured to apply the one or more signal attenuation levels is further configured to: apply a first signal attenuation level within the range of signal attenuation levels to the repeater; determine whether the oscillation ceases after the first signal attenuation level is applied; apply a second signal attenuation level within the range of signal attenuation levels to the repeater, wherein the first signal attenuation level and the second signal attenuation level are determined using successive approximation, wherein the second signal attenuation level is less than the first signal attenuation level when the oscillation has ceased after the first signal attenuation level is applied or the second signal attenuation level is greater than the first signal attenuation level when the oscillation has not ceased after the first signal attenuation level is applied; determine whether the oscillation ceases after the second signal attenuation level is applied; and iteratively apply additional signal attenuation levels within the range of signal attenuation levels to the repeater, wherein the additional signal attenuation levels are determined using successive approximation, wherein the additional signal attenuation levels are one or more of less than or greater than the second signal attenuation level and are iteratively applied until the minimum signal attenuation level is applied that mitigates the oscillation in the repeater.

Example 4 includes the repeater of any of Examples 1 to 3, wherein a number of signal attenuation levels that are applied to the repeater until the minimum signal attenuation level is applied corresponds to the range of signal attenuation levels that is applicable by the controller.

Example 5 includes the repeater of any of Examples 1 to 4, wherein the number of signal attenuation levels is equal to N when the range of signal attenuation levels includes 2^{N} signal attenuation levels, wherein N is a positive integer.

Example 6 includes the repeater of any of Examples 1 to 5, wherein the controller is configured to mitigate the oscillation in the repeater using successive approximation within an amount of time that complies with a maximum oscillation mitigation time limit defined by a governing body.

Example 7 includes the repeater of any of Examples 1 to 6, wherein the controller is configured to: increase a signal attenuation level to reduce a gain for the repeater; or decrease a signal attenuation level to increase a gain for the repeater.

Example 8 includes the repeater of any of Examples 1 to 7, wherein the signal attenuation levels in the range of signal attenuation levels are in increments of 0.5 decibels (dB).

Example 9 includes the repeater of any of Examples 1 to 8, wherein the signal attenuation levels in the range of signal attenuation levels are in increments of one decibel (dB).

Example 10 includes the repeater of any of Examples 1 to 9, wherein the signal attenuation levels in the range of signal attenuation levels are in increments of less than 2 decibels (dB).

Example 11 includes the repeater of any of Examples 1 to 10, wherein the signal path is an uplink signal path or a downlink signal path.

Example 12 includes the repeater of any of Examples 1 to 11, wherein the signal path includes one or more amplifiers and one or more filters to amplify and filter the signals in the defined band.

Example 13 includes the repeater of any of Examples 1 to 12, wherein the controller is configured to detect the oscillation in the repeater based on signal information received from a radio frequency (RF) signal detector in the repeater.

Example 14 includes a method for mitigation an oscillation in a repeater, the method comprising: detecting, at a controller in the repeater, an oscillation in the repeater; determining, at the controller, a range of signal attenuation levels that are applicable by the controller; and applying, using the controller, one or more signal attenuation levels within the range of signal attenuation levels to the repeater to mitigate the oscillation, wherein a signal attenuation level is iteratively adjusted until a minimum signal attenuation level within the range of signal attenuation levels is applied that mitigates the oscillation in the repeater.

Example 15 includes the method of Example 14, further comprising: detecting the oscillation in a defined band or in a signal path of the repeater; and applying the one or more signal attenuation levels within the range of signal attenuation levels to the defined band or to the signal path of the repeater.

Example 16 includes the method of any of Examples 14 to 15, wherein applying the one or more signal attenuation levels comprises: applying a first signal attenuation level within the range of signal attenuation levels to the repeater; determining that the oscillation does not cease after the first signal attenuation level is applied to the repeater; determining a modified range of signal attenuation levels when applying the first signal attenuation level does not cease the oscillation in the repeater; applying a second signal attenuation level within the modified range of signal attenuation levels to the repeater; determining whether the oscillation has ceased after the second signal attenuation level is applied to the repeater; and applying additional signal attenuation levels within the modified range of signal attenuation levels until the minimum signal attenuation level is applied that mitigates the oscillation in the repeater.

Example 17 includes the method of any of Examples 14 to 16, wherein: the first signal attenuation level is equal to half of the range of signal attenuation levels; and the second signal attenuation level is equal to half of the modified range of signal attenuation levels.

Example 18 includes the method of any of Examples 14 to 17, wherein applying the one or more signal attenuation levels comprises: applying a first signal attenuation level within the range of signal attenuation levels to the repeater; determining that the oscillation ceases after the first signal attenuation level is applied to the repeater; applying a second signal attenuation level within the range of signal attenuation levels to the repeater; determining whether the oscillation has ceased after the second signal attenuation level is applied to the repeater; and applying additional signal attenuation levels within the range of signal attenuation levels until the minimum signal attenuation level is applied that mitigates the oscillation in the repeater.

Example 19 includes the method of any of Examples 14 to 18, wherein: the first signal attenuation level is equal to half of the range of signal attenuation levels; and the second signal attenuation level is equal to half of the first signal attenuation level.

Example 20 includes the method of any of Examples 14 to 19, further comprising iteratively adjusting the signal attenuation level using successive approximation until the minimum signal attenuation level within the range of signal attenuation levels is applied that mitigates the oscillation in the repeater.

Example 21 includes the method of any of Examples 14 to 20, further comprising applying an additional signal attenuation level to create an oscillation margin, wherein the additional signal attenuation level reduces a gain in the repeater.

Example 22 includes the method of any of Examples 14 to 21, further comprising: applying additional signal attenuation levels to create an offset to an oscillation margin, wherein the additional signal attenuation levels reduce a gain in the repeater; and periodically increasing a gain in the repeater, wherein the offset to the oscillation margin reduces a likelihood that the increase to the gain causes a subsequent oscillation at the repeater.

Example 23 includes a signal booster operable to mitigate an oscillation, the signal booster comprising: a signal path configured to carry a signal in a defined band; and a controller configured to: detect an oscillation in the signal booster; determine a range of signal attenuation levels that are applicable by the controller; and apply one or more signal attenuation levels within the range of signal attenuation levels to the signal booster to mitigate the oscillation, wherein a signal attenuation level is iteratively adjusted until a minimum signal attenuation level within the range of signal attenuation levels is applied that mitigates the oscillation in the signal booster.

Example 24 includes the signal booster of Example 23, wherein the controller is configured to: detect the oscillation in the defined band or in the signal path of the signal booster; and apply the one or more signal attenuation levels within the range of signal attenuation levels to the defined band or to the signal path of the signal booster.

Example 25 includes the signal booster of any of Examples 23 to 24, wherein the controller is configured to iteratively adjust the signal attenuation level using successive approximation until the minimum signal attenuation level within the range of signal attenuation levels is applied that mitigates the oscillation in the signal booster.

Example 26 includes the signal booster of any of Examples 23 to 25, wherein the controller is configured to apply an additional signal attenuation level to create an oscillation margin, wherein the additional signal attenuation level reduces a gain in the signal booster.

Example 27 includes the signal booster of any of Examples 23 to 26, wherein the controller is configured to: apply additional signal attenuation levels to create an offset to an oscillation margin, wherein the additional signal attenuation levels reduce a gain in the signal booster; and periodically increase a gain in the signal booster, wherein the offset to the oscillation margin reduces a likelihood that the increase to the gain causes a subsequent oscillation at the signal booster.

Various techniques, or certain aspects or portions thereof, can take the form of program code (i.e., instructions) embodied in tangible media, such as floppy diskettes, compact disc-read-only memory (CD-ROMs), hard drives, non-transitory computer readable storage medium, or any other machine-readable storage medium wherein, when the program code is loaded into and executed by a machine, such as a computer, the machine becomes an apparatus for practicing the various techniques. Circuitry can include hardware, firmware, program code, executable code, computer instructions, and/or software. A non-transitory computer readable storage medium can be a computer readable storage medium that does not include signal. In the case of program code execution on programmable computers, the computing device can include a processor, a storage medium readable by the processor (including volatile and non-volatile memory and/or storage elements), at least one input device, and at least one output device. The volatile and non-volatile memory and/or storage elements can be a random-access memory (RAM), erasable programmable read only memory (EPROM), flash drive, optical drive, magnetic hard drive, solid state drive, or other medium for storing electronic data. One or more programs that can implement or utilize the various techniques described herein can use an application programming interface (API), reusable controls, and the like. Such programs can be implemented in a high level procedural or object oriented programming language to communicate with a computer system. However, the program(s) can be implemented in assembly or machine language, if desired. In any case, the language can be a compiled or interpreted language, and combined with hardware implementations.

As used herein, the term processor can include general purpose processors, specialized processors such as VLSI, FPGAs, or other types of specialized processors, as well as base band processors used in transceivers to send, receive, and process wireless communications.

It should be understood that many of the functional units described in this specification have been labeled as modules, in order to more particularly emphasize their implementation independence. For example, a module can be implemented as a hardware circuit comprising custom very-large-scale integration (VLSI) circuits or gate arrays, off-the-shelf semiconductors such as logic chips, transistors, or other discrete components. A module can also be implemented in programmable hardware devices such as field programmable gate arrays, programmable array logic, programmable logic devices or the like.

In one example, multiple hardware circuits or multiple processors can be used to implement the functional units described in this specification. For example, a first hardware circuit or a first processor can be used to perform processing operations and a second hardware circuit or a second processor (e.g., a transceiver or a baseband processor) can be used to communicate with other entities. The first hardware circuit and the second hardware circuit can be incorporated into a single hardware circuit, or alternatively, the first hardware circuit and the second hardware circuit can be separate hardware circuits.

Modules can also be implemented in software for execution by various types of processors. An identified module of executable code can, for instance, comprise one or more physical or logical blocks of computer instructions, which can, for instance, be organized as an object, procedure, or function. Nevertheless, the executables of an identified module need not be physically located together, but can comprise disparate instructions stored in different locations which, when joined logically together, comprise the module and achieve the stated purpose for the module.

Indeed, a module of executable code can be a single instruction, or many instructions, and can even be distributed over several different code segments, among different programs, and across several memory devices. Similarly, operational data can be identified and illustrated herein within modules, and can be embodied in any suitable form and organized within any suitable type of data structure. The operational data can be collected as a single data set, or can be distributed over different locations including over different storage devices, and can exist, at least partially, merely as electronic signals on a system or network. The modules can be passive or active, including agents operable to perform desired functions.

Reference throughout this specification to “an example” or “exemplary” means that a particular feature, structure, or characteristic described in connection with the example is included in at least one embodiment of the present invention. Thus, appearances of the phrases “in an example” or the word “exemplary” in various places throughout this specification are not necessarily all referring to the same embodiment.

As used herein, a plurality of items, structural elements, compositional elements, and/or materials can be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention can be referred to herein along with alternatives for the various components thereof. It is understood that such embodiments, examples, and alternatives are not to be construed as defacto equivalents of one another, but are to be considered as separate and autonomous representations of the present invention.

Furthermore, the described features, structures, or characteristics can be combined in any suitable manner in one or more embodiments. In the following description, numerous specific details are provided, such as examples of layouts, distances, network examples, etc., to provide a thorough understanding of embodiments of the invention. One skilled in the relevant art will recognize, however, that the invention can be practiced without one or more of the specific details, or with other methods, components, layouts, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A repeater operable to mitigate an oscillation, the repeater comprising:
a signal path configured to carry a signal in a defined band; and
a controller configured to:
detect an oscillation in the repeater;
determine a range of signal attenuation levels that are applicable by the controller; and
apply one or more signal attenuation levels within the range of signal attenuation levels to the repeater to mitigate the oscillation, wherein a signal attenuation level is iteratively adjusted using successive approximation until a minimum signal attenuation level within the range of signal attenuation levels is applied that mitigates the oscillation in the repeater.

2. The repeater of claim 1, wherein the controller is configured to:
detect the oscillation in the defined band or in the signal path of the repeater; and
apply the one or more signal attenuation levels within the range of signal attenuation levels to the defined band or to the signal path of the repeater.

3. The repeater of claim 1, wherein the controller configured to apply the one or more signal attenuation levels is further configured to:
apply a first signal attenuation level within the range of signal attenuation levels to the repeater;
determine whether the oscillation ceases after the first signal attenuation level is applied;
apply a second signal attenuation level within the range of signal attenuation levels to the repeater, wherein the first signal attenuation level and the second signal attenuation level are determined using successive approximation, wherein the second signal attenuation level is less than the first signal attenuation level when the oscillation has ceased after the first signal attenuation level is applied or the second signal attenuation level is greater than the first signal attenuation level when the oscillation has not ceased after the first signal attenuation level is applied;
determine whether the oscillation ceases after the second signal attenuation level is applied; and
iteratively apply additional signal attenuation levels within the range of signal attenuation levels to the repeater, wherein the additional signal attenuation levels are determined using successive approximation, wherein the additional signal attenuation levels are one or more of less than or greater than the second signal attenuation level and are iteratively applied until the minimum signal attenuation level is applied that mitigates the oscillation in the repeater.

4. The repeater of claim 1, wherein a number of signal attenuation levels that are applied to the repeater until the minimum signal attenuation level is applied corresponds to the range of signal attenuation levels that is applicable by the controller.

5. The repeater of claim 4, wherein the number of signal attenuation levels is equal to N when the range of signal attenuation levels includes 2^{N} signal attenuation levels, wherein N is a positive integer.

6. The repeater of claim 1, wherein the controller is configured to mitigate the oscillation in the repeater using successive approximation within an amount of time that complies with a maximum oscillation mitigation time limit defined by a governing body.

7. The repeater of claim 1, wherein the controller is configured to:
increase a signal attenuation level to reduce a gain for the repeater; or
decrease a signal attenuation level to increase a gain for the repeater.

8. The repeater of claim 1, wherein the signal attenuation levels in the range of signal attenuation levels are in increments of 0.5 decibels (dB).

9. The repeater of claim 1, wherein the signal attenuation levels in the range of signal attenuation levels are in increments of one decibel (dB).

10. The repeater of claim 1, wherein the signal attenuation levels in the range of signal attenuation levels are in increments of less than 2 decibels (dB).

11. The repeater of claim 1, wherein the signal path is an uplink signal path or a downlink signal path.

12. The repeater of claim 1, wherein the signal path includes one or more amplifiers and one or more filters to amplify and filter the signals in the defined band.

13. The repeater of claim 1, wherein the controller is configured to detect the oscillation in the repeater based on signal information received from a radio frequency (RF) signal detector in the repeater.

14. A method for mitigating an oscillation in a repeater, the method comprising:
detecting, at a controller in the repeater, an oscillation in the repeater;
determining, at the controller, a range of signal attenuation levels that are applicable by the controller; and
applying, using the controller, one or more signal attenuation levels within the range of signal attenuation levels to the repeater to mitigate the oscillation, wherein a signal attenuation level is iteratively adjusted until a minimum signal attenuation level within the range of signal attenuation levels is applied that mitigates the oscillation in the repeater.

15. The method of claim 14, further comprising:
detecting the oscillation in a defined band or in a signal path of the repeater; and
applying the one or more signal attenuation levels within the range of signal attenuation levels to the defined band or to the signal path of the repeater.

16. The method of claim 14, wherein applying the one or more signal attenuation levels comprises:
applying a first signal attenuation level within the range of signal attenuation levels to the repeater;
determining that the oscillation does not cease after the first signal attenuation level is applied to the repeater;
determining a modified range of signal attenuation levels when applying the first signal attenuation level does not cease the oscillation in the repeater;
applying a second signal attenuation level within the modified range of signal attenuation levels to the repeater;
determining whether the oscillation has ceased after the second signal attenuation level is applied to the repeater; and
applying additional signal attenuation levels within the modified range of signal attenuation levels until the minimum signal attenuation level is applied that mitigates the oscillation in the repeater.

17. The method of claim 16, wherein:
the first signal attenuation level is equal to half of the range of signal attenuation levels; and
the second signal attenuation level is equal to half of the modified range of signal attenuation levels.

18. The method of claim 14, wherein applying the one or more signal attenuation levels comprises:
applying a first signal attenuation level within the range of signal attenuation levels to the repeater;
determining that the oscillation ceases after the first signal attenuation level is applied to the repeater;
applying a second signal attenuation level within the range of signal attenuation levels to the repeater;
determining whether the oscillation has ceased after the second signal attenuation level is applied to the repeater; and
applying additional signal attenuation levels within the range of signal attenuation levels until the minimum signal attenuation level is applied that mitigates the oscillation in the repeater.

19. The method of claim 18, wherein:
the first signal attenuation level is equal to half of the range of signal attenuation levels; and the second signal attenuation level is equal to half of the first signal attenuation level.

20. The method of claim 14, further comprising iteratively adjusting the signal attenuation level using successive approximation until the minimum signal attenuation level within the range of signal attenuation levels is applied that mitigates the oscillation in the repeater.

21. The method of claim 14, further comprising applying an additional signal attenuation level to create an oscillation margin, wherein the additional signal attenuation level reduces a gain in the repeater.

22. The method of claim 14, further comprising:
applying additional signal attenuation levels to create an offset to an oscillation margin, wherein the additional signal attenuation levels reduce a gain in the repeater; and
periodically increasing a gain in the repeater, wherein the offset to the oscillation margin reduces a likelihood that the increase to the gain causes a subsequent oscillation at the repeater.

23. A signal booster operable to mitigate an oscillation, the signal booster comprising:
a signal path configured to carry a signal in a defined band; and
a controller configured to:
detect an oscillation in the signal booster;
determine a range of signal attenuation levels that are applicable by the controller; and
apply one or more signal attenuation levels within the range of signal attenuation levels to the signal booster to mitigate the oscillation, wherein a signal attenuation level is iteratively adjusted until a minimum signal attenuation level within the range of signal attenuation levels is applied that mitigates the oscillation in the signal booster.

24. The signal booster of claim 23, wherein the controller is configured to:
detect the oscillation in the defined band or in the signal path of the signal booster; and
apply the one or more signal attenuation levels within the range of signal attenuation levels to the defined band or to the signal path of the signal booster.

25. The signal booster of claim 23, wherein the controller is configured to iteratively adjust the signal attenuation level using successive approximation until the minimum signal attenuation level within the range of signal attenuation levels is applied that mitigates the oscillation in the signal booster.

26. The signal booster of claim 23, wherein the controller is configured to apply an additional signal attenuation level to create an oscillation margin, wherein the additional signal attenuation level reduces a gain in the signal booster.

27. The signal booster of claim 23, wherein the controller is configured to:
apply additional signal attenuation levels to create an offset to an oscillation margin, wherein the additional signal attenuation levels reduce a gain in the signal booster; and
periodically increase a gain in the signal booster, wherein the offset to the oscillation margin reduces a likelihood that the increase to the gain causes a subsequent oscillation at the signal booster.
